(19) United States
(12) Patent Application Publication
(10) Pub. No.: US 2014/0049540 A1
(43) Pub. Date: Feb. 20, 2014

(54) Image Processing Device, Method, Computer Program Product, and Stereoscopic Image Display Device

(71) Applicant: Kabushiki Kaisha Toshiba, Tokyo (JP)

(72) Inventors: Kenichi SHIMOYAMA, Tokyo (JP); Takeshi Mita, Kanagawa (JP); Masahiro Baba, Kanagawa (JP); Ryusuke Hirai, Tokyo (JP); Yoshiyuki Kokojima, Kanagawa (JP)

(73) Assignee: Kabushiki Kaisha Toshiba, Tokyo (JP)

(21) Appl. No.: 14/037,701

(22) Filed: Sep. 26, 2013

Related U.S. Application Data
(63) Continuation of application No. PCT/JP2011/057546, filed on Mar. 28, 2011.

(51) Int. Cl. G02B 27/22; G06T 15/00

(52) U.S. Cl. CPC G02B 27/225; G02B 27/22; G06T 15/00
USPC 345/419; 359/464

(57) ABSTRACT

According to one embodiment, an image processing device includes an observing unit and a generating unit. The observing unit obtains an observation image by observing a viewer which views a display unit. The generating unit generates a presentation image in which visible area is superimposed on the observation image. The visible area is an area within which the viewer is able to view the stereoscopic image. A display form of the visible area changes based on a position of the viewer in a perpendicular direction to the display unit.

### CROSS-REFERENCE TO RELATED APPLICATIONS

This application is a continuation of International Application No. PCT/JP2011/057546, filed on Mar. 28, 2011, which designates the United States; the entire contents of which are incorporated herein by reference.

### FIELD

Embodiments described herein relate generally to an image processing device, a method, a computer program product and a stereoscopic image display device.

### BACKGROUND

A stereoscopic image display device enables a viewer to view stereoscopic images with the unaided eye without having to use special glasses. In such a stereoscopic image display device, a plurality of images having different viewpoints is displayed and the light beams coming out from those images are separated using a spectroscopic element such as a parallax barrier or a lenticular lens. Then, the separated light beams are guided to both eyes of the viewer. If the viewing position of the viewer is appropriate, it becomes possible for the viewer to recognize a stereoscopic image. The area of viewing positions within which a stereoscopic image can be recognized by the viewer is called a visible area.

However, such a visible area is only a limited area. That is, for example, there exists a reverse visible area that includes viewing positions at which the viewpoints of images perceived by the left eye are on the right-hand side relative to the viewpoints of images perceived by the right eye, thereby leading to a condition in which stereoscopic images cannot be recognized in a correct manner. For that reason, in a glasses-free stereoscopic image display device, it is difficult for the viewer to view satisfactory stereoscopic images.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram illustrating an image processing device according to a first embodiment;

FIG. 2 is an exemplary diagram illustrating an example of an observation image according to the first embodiment;

FIG. 3 is an exemplary diagram illustrating an example of visible area information according to the first embodiment;

FIG. 4 is an exemplary diagram illustrating an example of a presentation image according to the first embodiment;

FIG. 5 is an exemplary diagram illustrating an example of the visible area information according to the first embodiment when a plurality of viewers is present;

FIGS. 6A, 6B and 6C are exemplary diagrams illustrating an example of a presentation image according to the first embodiment;

FIG. 7 is an exemplary diagram illustrating an example of transitions in a presentation image according to the first embodiment;

FIG. 8 is an exemplary diagram illustrating an example of a presentation image according to the first embodiment;

FIG. 9 is an exemplary diagram illustrating an example of a presentation image according to the first embodiment;

FIG. 10 is an exemplary flowchart for explaining a presentation image generating operation performed according to the first embodiment;

FIG. 11 is an exemplary diagram illustrating an image processing device according to a second embodiment;

FIGS. 12A and 12B are exemplary diagrams illustrating an example of a presentation image and presentation information according to the second embodiment;

FIG. 13 is an exemplary diagram illustrating an example of a presentation image and presentation information according to the second embodiment;

FIG. 14 is an exemplary diagram illustrating an example of a presentation image and presentation information according to the second embodiment;

FIGS. 15A, 15B and 15C are exemplary diagrams illustrating an example of presentation information according to the second embodiment;

FIG. 16 is an exemplary diagram illustrating an example of presentation information according to the second embodiment;

FIG. 17 is an exemplary diagram illustrating an example of presentation information according to the second embodiment;

FIG. 18 is an exemplary flowchart for explaining a presentation information generating operation performed according to the second embodiment;

FIG. 19 is an exemplary diagram illustrating an image processing device according to a third embodiment;

FIG. 20 is an exemplary diagram for explaining controlling of the visible area according to the third embodiment; and

FIG. 21 is an exemplary flowchart for explaining a presentation information generating operation performed according to the third embodiment.

### DETAILED DESCRIPTION

In general, according to one embodiment, an image processing device comprising an observing unit and a generating unit. The observing unit is configured to obtain an observation image by observing a viewer which views a display unit. The display unit is capable of displaying a stereoscopic image. The generating unit is configured to generate a presentation image in which visible area is superimposed on the observation image by using visible area information indicating the visible area. The visible area is an area within which the viewer is able to view the stereoscopic image. A display form of the visible area changes based on a position of the viewer in a perpendicular direction to the display unit.

### First Embodiment

An image processing device 100 according to a first embodiment can be suitably implemented in a TV or a PC that enables a viewer to view stereoscopic images with the unaided eye. Herein, a stereoscopic image points to an image that contains a plurality of parallax images having parallaxes with each other.

The image processing device 100 generates a presentation image in which a real-space area, within which viewers can stereoscopically view stereoscopic images (i.e., a visible area), is superimposed on an image for observing one or more viewers (i.e., an observation image), and presents the presentation image to the viewers. With that, it becomes possible for the viewers to easily recognize the visible area. Meanwhile, in the embodiments, an image can either be a still image or a moving image.

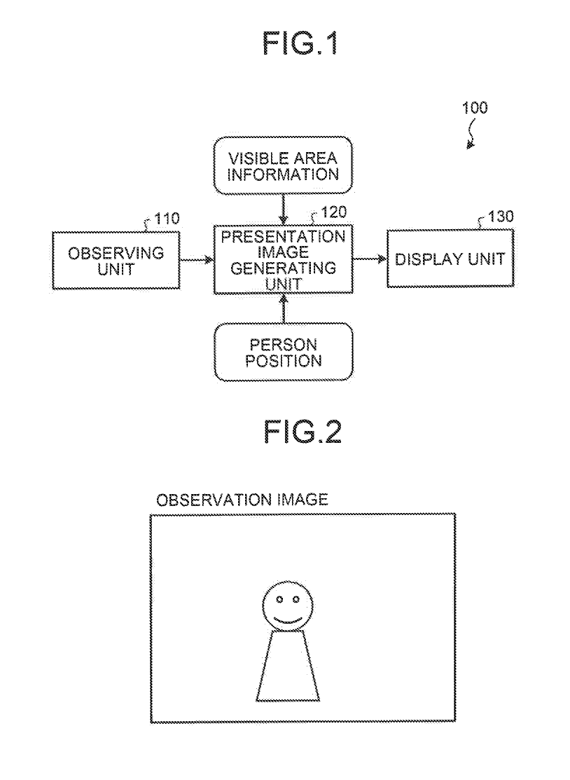

FIG. 1 is a block diagram illustrating the image processing device 100. Herein, the image processing device 100 is capable of displaying stereoscopic images and includes an observing unit 110, a presentation image generating unit 120, and a display unit 130 as illustrated in FIG. 1.

The observing unit 110 observes the viewers and generates an observation image that indicates the positions of the viewers within the viewing area. Herein, the viewing area points to the area from which the display surface of the display unit 130 is viewable. The position of a viewer within the viewing area points to, for example, the position of that viewer with respect to the display unit 130. FIG. 2 is a diagram illustrating an example of the observation image. As illustrating in FIG. 2, in the observation image is displayed the position of a viewer within the viewing area. Thus, the observation image can be an image capturing the viewer from the position of the display unit 130. In this case, the observing unit 110 is disposed at the position of the display unit 130.

In the first embodiment, the observing unit 110 can be a visible camera, an infrared camera, a radar, or a sensor. However, in the case of using a sensor as the observing unit 110, it is not possible to directly obtain an observation image. Hence, it is desirable to generate an observation image using CG (Computer Graphics) or animation.

The presentation image generating unit 120 generates a presentation image by superimposing visible area information on the observation image. Herein, the visible area information indicates the distribution of visible areas in the real space. In the first embodiment, the visible area information is stored in advance in a memory medium such as a memory (not illustrated) in the image processing device 100.

More particularly, based on a person position, which is position information indicating the positions of viewers, and based on the visible area information; the presentation image generating unit 120 generates a presentation image in which relative position relationship between each viewer and the visible area is superimposed on an observation image. Herein, the relative position relationship between a viewer and the visible area indicates whether that viewer who is captured in the observation image is present within the visible area or is present outside the visible area. In the first embodiment, the person position is stored in advance in a memory medium such as a memory (not illustrated) in the image processing device 100.

Moreover, in the first embodiment, the top-left corner of an observation image is considered as the origin, the horizontal direction is set as the x-axis, and the vertical direction is set as the y-axis. However, the method of coordinate setting is not limited to this method.

In the real space, the center of the display surface of the display unit 130 is considered as the origin, the horizontal transverse direction is set as the X-axis, the vertical direction is set as the Y-axis, and the normal direction of the display surface of the display unit 130 is set as the Z-axis. However, the method of coordinate setting in the real space is not limited to this method. Thus, under assumption of the description given above, the position of i-th viewer is represented as Pi(Xi, Yi, Zi).

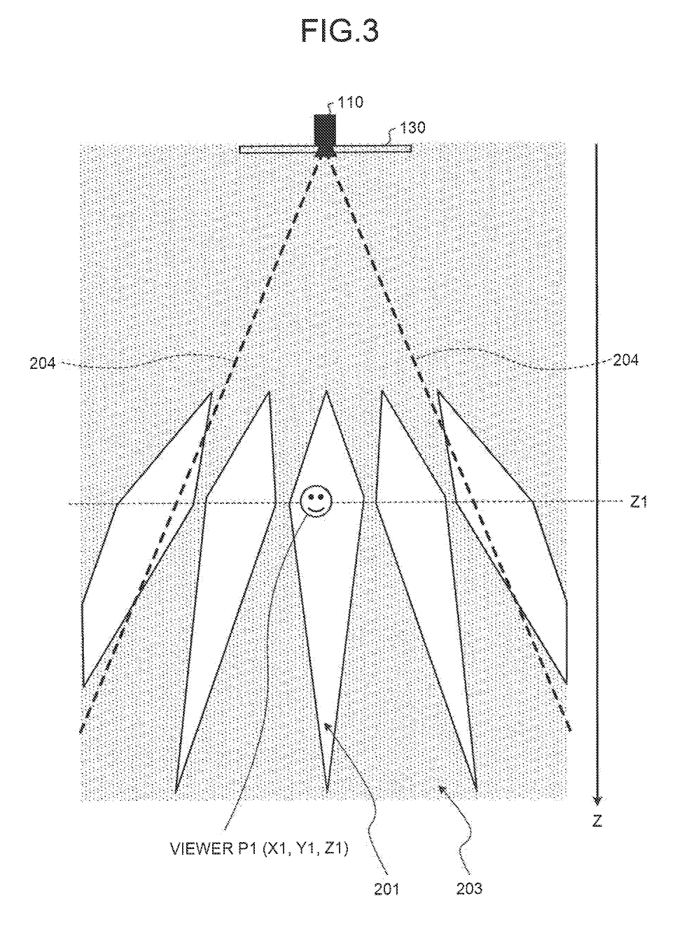

Explained below are the details regarding the visible area information. FIG. 3 is a schematic diagram illustrating an example of the visible area information. In FIG. 3 is illustrated a condition in which the viewing area is captured from above as a long shot. In FIG. 3, white oblong regions represent a range 201 within the visible area. On the other hand, the hatched area represents a range 203 outside the visible area. Herein, due to the occurrence of reverse vision or crosstalk, it is difficult to obtain a satisfactory stereoscope view.

In the example illustrated in FIG. 3, since a viewer P1 is present within the visible area 201, it is possible for the viewer P1 to have a satisfactory stereoscopic view. Meanwhile, if the combination of the display unit 130 (display) and the image to be displayed is known; then the visible area 201 can be obtained geometrically.

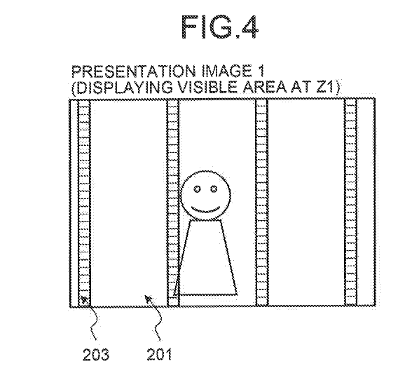

The presentation image generating unit 120 generates a presentation image by merging, that is, superimposing the visible area information illustrated in FIG. 3 on the observation image illustrated in FIG. 2. FIG. 4 is a schematic diagram illustrating an example of a presentation image that is generated by referring to the visible area information illustrated in FIG. 3 and the observation image illustrated in FIG. 2.

In the visible area information illustrated in FIG. 3, the viewer P1 is present at a coordinate P1 (X1, Y1, Z1). In that visible area information, if the condition of the visible area at a distance Z1 is superimposed on the observation image, then it results in the formation of the presentation image illustrated in FIG. 4. In that presentation image, if the area 201 is illustrated as a blank area and if a horizontal line pattern is superimposed on the range 203 outside the visible area, then it becomes possible to make the viewer understand the relative position relationship between himself or herself and the inside of the visible area and the outside of the visible area. If such a presentation image is generated, the viewer can easily understand the direction of movement for the purpose of entering the visible area. As a result, it becomes possible to view stereoscopic images in a more satisfactory manner.

Meanwhile, in the example illustrated in FIG. 4, the distance from the display unit 130 to the visible area to be superimposed matches with the distance from the display unit 130 to the viewer. However, those distances need not match. For example, the visible area information to be superimposed can be visible area information of the position at which the width of the visible area is the largest.

Based on the visible area information and the range of observation image, the presentation image generating unit 120 generates a presentation image at the distance Z1 in the following manner. In the example of the visible area information illustrated in FIG. 3, a camera is used as the observing unit 110 and a range defined by two dotted lines 204 indicates the angle of view of the camera. Then, within a range formed when the boundaries 204 of the angle of view of the camera cut off a straight line represented by Z=Z1, the changes occurring in the visible area are merged with the observation image, and accordingly a presentation image is generated.

Alternatively, the presentation image generating unit 120 can generate a presentation image by mirror-reversing an image in which the visible area is superimposed on the observation image. That is, the presentation image generating unit 120 can convert the presentation image into a mirror image (i.e., an image that is recognized as if the viewer is reflected in a mirror). With that, the viewer becomes able to see his or her mirror image containing the visible area information. Hence, the viewer can instinctively get to know whether he or she is present within the visible area range.

In the example of the presentation image illustrated in FIG. 4, the range outside the visible area is indicated by horizontal line patterns so as to display the relationship between the inside of the visible area and the outside of the visible area. However, that is not the only possible case. For example, the area on the outside of the visible area can be indicated using various methods such as superimposing or displaying a pattern such as a hatching pattern or a diagonal line pattern as the outside area; or enclosing the outside area in a frame border; or superimposing or displaying certain colors as the outside area; or displaying the outside area in black color; or displaying the outside area in gradation; or displaying the outside area in mosaic; or displaying the outside area by performing negative-positive reversal; or displaying the outside area in grayscale; or displaying the outside area in a faint color. Moreover, the presentation image generating unit 120 can be configured to combine these methods and indicate the area on the outside of the visible area.

Thus, as long as the display format enables the viewer to distinguish between the inside of the visible area and the outside of the visible area, it is possible to implement any method. That is, a presentation image can be generated in which the area on the inside of the visible area is displayed in the abovementioned display format.

Meanwhile, in the case when a plurality of viewers is present, the presentation image generating unit 120 according to the first embodiment refers to the position information of each of the plurality of viewers and refers to the visible area information; and generates, for each viewer, a presentation image in which the relative position relationship between that viewer and the visible area is superimposed on the observation image. That is, for each viewer, the presentation image generating unit 120 generates a presentation image that indicates whether the viewer captured in the observation image is present within the visible area or is present outside the visible area.

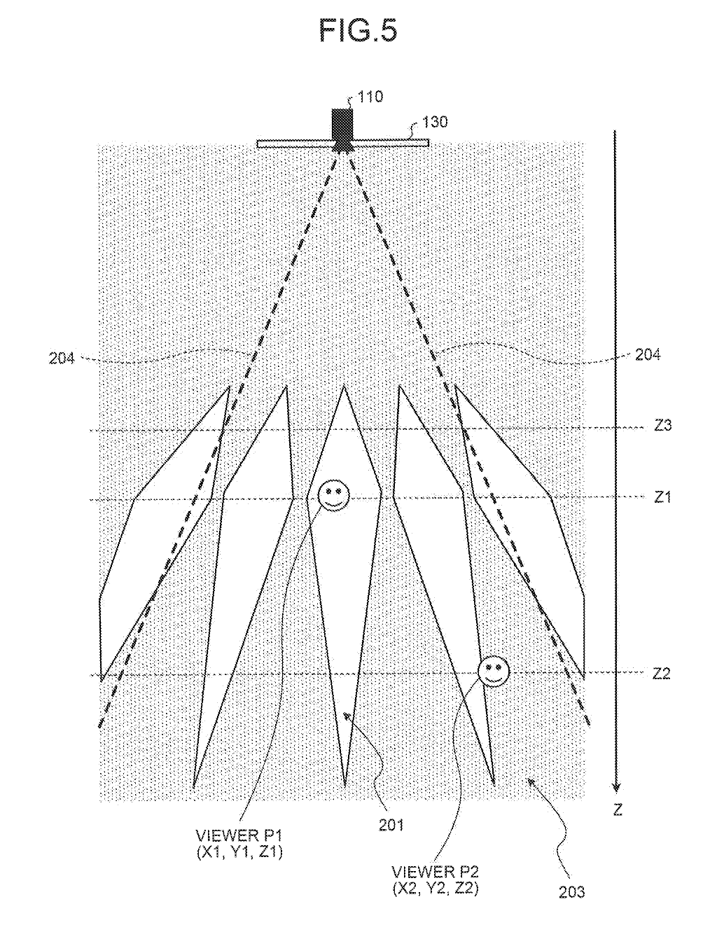

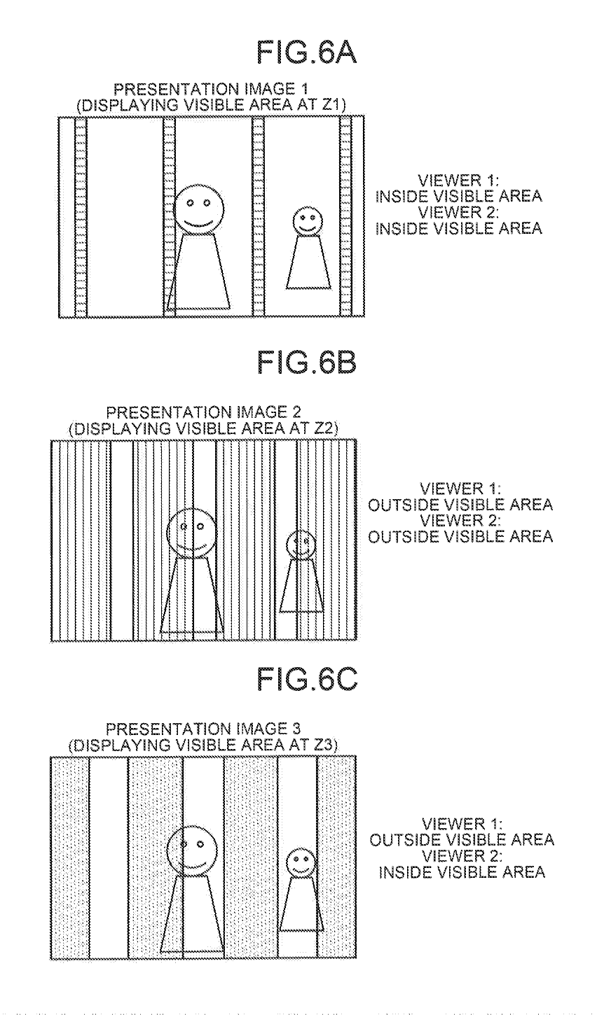

FIG. 5 is a schematic diagram illustrating an example of the visible area information when a plurality of viewers is present. In the example illustrated in FIG. 5, two viewers are present. The position coordinates of the viewer P1 are (X1, Y1, Z1) and the position coordinates of a viewer P2 are (X2, Y2, Z2). In the example illustrated in FIG. 5, the viewer P1 is present inside the visible area, while the viewer P2 is present outside the visible area. In such a case, when presentation images are generated using the visible areas at distances Z1, Z2, and Z3; then conditions illustrated in FIG. 6(a) to FIG. 6(c) are obtained. FIG. 6(a) illustrates an example of the presentation image at the distance Z1; FIG. 6(b) illustrates an example of the presentation image at the distance Z2; and FIG. 6(c) illustrates an example of the presentation image at the distance Z3.

As illustrated in FIG. 6(a), in a presentation image 1 at the distance Z1, both the viewer P1 and the viewer P2 appear to be inside the visible area. However, as illustrated in FIG. 5, at the distance Z1, actually the viewer P2 is present outside the visible area. That is because of the fact that the distance Z1 of the visible area used while generating the presentation image is different than the distance of the viewer P2.

In an identical manner, as illustrated in FIG. 6(b), in a presentation image 2 at the distance Z2; both the viewer P1 and the viewer P2 appear to be outside the visible area. However, as illustrated in FIG. 5, at the distance Z2, actually the viewer P1 is present inside the visible area. Moreover, as illustrated in FIG. 6(c), in a presentation image 3 at the distance Z3; the viewer P1 appears to be outside the visible area and the viewer P2 appears to be inside the visible area. However, as illustrated in FIG. 5, at the distance Z3, actually the viewer P1 is present inside the visible area and the viewer P2 is present outside the visible area.

For that reason, when a plurality of viewers is present, the presentation image generating unit 120 according to the first embodiment generates one or more presentation images using the visible area information in the neighborhood of the distance in the Z-axis direction (i.e., Z-coordinate position) of each viewer. As a result, the actual position of a viewer inside or outside the visible area is matched with the position indicated in the presentation images.

More particularly, when a plurality of viewers is present, the presentation image generating unit 120 refers to the Z-coordinate position from the person position of each viewer; obtains the visible area range at each Z-coordinate position from a visible area information map, that is, obtains the visible area position and the visible area width at each Z-coordinate position; and generates, for each viewer, presentation information that indicates the existence position of that viewer inside or outside the visible area.

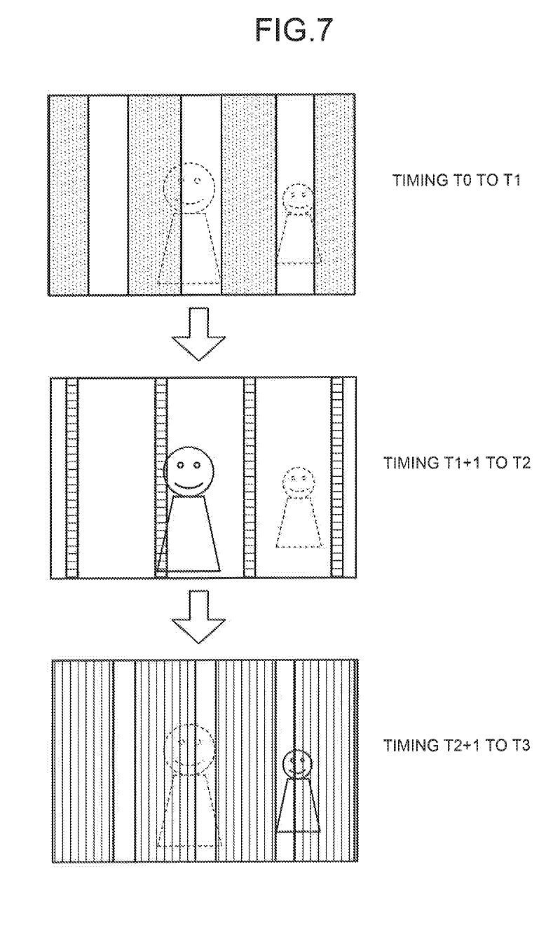

Following are some exemplary methods for generating such presentation information. For example, as illustrated in FIG. 7, the presentation image generating unit 120 can generate a plurality of presentation images with respect to the viewers or the Z-coordinate positions (i.e., the distances in the Z-axis direction) and can send the presentation images to the display unit 130 for the displaying purpose in a time-sharing manner at regular time intervals.

In this case, it is desirable to configure the presentation image generating unit 120 to give notice about the viewer to whom the presentation image at a particular timing corresponds. For example, a display format can be adopted in which the viewer corresponding to the currently-displayed presentation image is colored with a given color or is marked out; or a display format can be adopted in which the viewers not corresponding to the currently-displayed presentation image are not marked with a given color or are filled with black color.

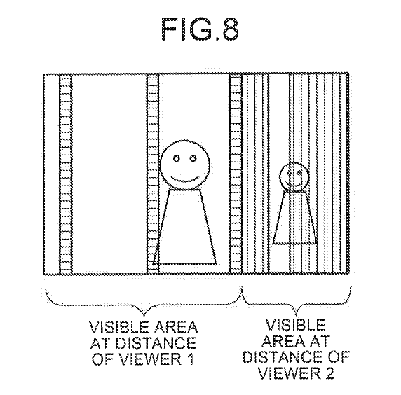

Alternatively, as illustrated in FIG. 8, a method can be implemented in which the presentation image generating unit 120 generates a presentation image in which, in the neighborhood of each viewer, the visible area at the distance of that viewer is superimposed.

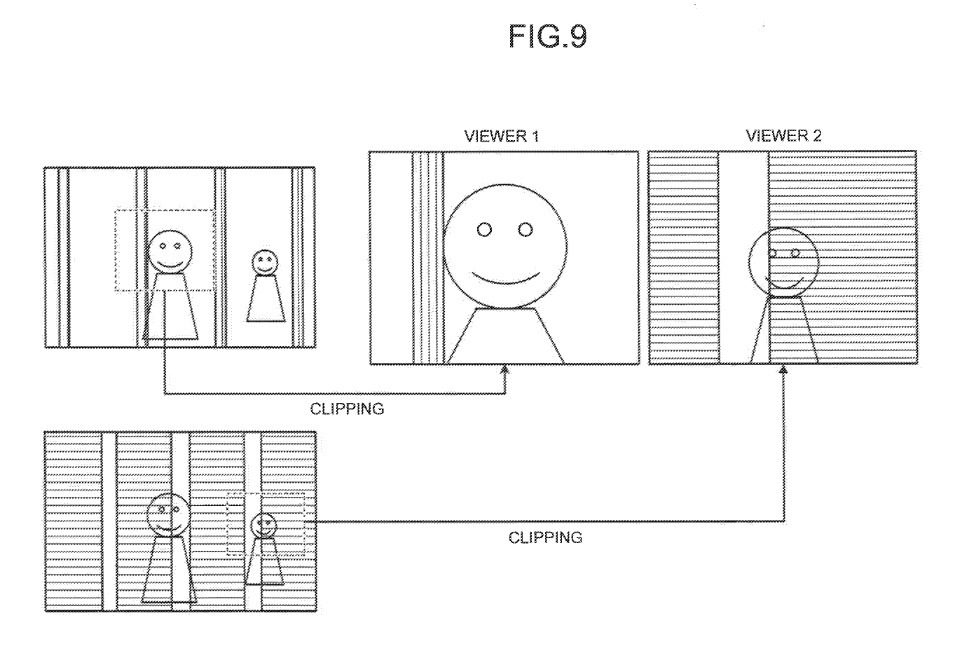

Still alternatively, as illustrated in FIG. 9, the presentation image generating unit 120 can implement a method in which presentation images are generated by clipping the neighborhood areas of the viewers and enlarging the clipped portions. As another example, from the position of each viewer, the presentation image generating unit 120 works out the light beams coming out from the parallax image visible to the that viewer; and displays the presentation image generated for that viewer on the corresponding parallax image.

Meanwhile, the presentation image generating unit 120 can also be configured to superimpose other visible area information on a presentation image. For example, the presentation image generating unit 120 can be configured to superimpose, on a presentation image, the manner of distribution of parallax images in the real space.

Returning to the explanation with reference to FIG. 1, the display unit 130 is a display device, such as a display, that displays the presentation image generated by the presentation image generating unit 120. Herein, various displaying methods can be implemented using the display unit 130. For example, it is possible to display a presentation image in full-screen mode or in some portion of the display; or it is possible to use a dedicated display device for the purpose of displaying presentation images.

In the case of configuring the display unit 130 to be capable of displaying presentation images as well as stereoscopic images, a lenticular lens functioning as a display as well as a light beam control element can be used as the display unit 130. Moreover, the display unit 130 can be installed in an operating device such as a remote controller, and can display presentation images (described later) independent of stereoscopic images. Alternatively, the display unit 130 can be configured as a display unit of the handheld devices of viewers so that presentation images can be sent to the handheld devices and displayed thereon.

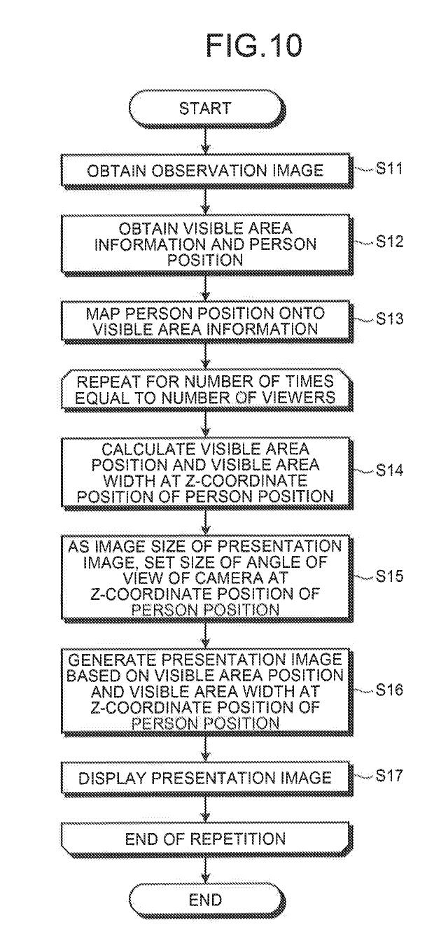

Explained below with reference to a flowchart illustrated FIG. 10 is a presentation image generating operation performed in the image processing device 100 configured in the abovementioned manner according to the first embodiment.

Firstly, the observing unit 110 observes the viewers and obtains an observation image (Step S11). Then, the presentation image generating unit 120 obtains visible area information and person positions, which indicate the position coordinates of the viewers, from a memory (not illustrated) (Step S12).

Subsequently, the presentation image generating unit 120 performs mapping of the person positions onto the visible area information (Step S13), and gets to know the number of viewers and the position of each viewer in the visible area information.

Then, the presentation image generating unit 120 calculates, from the visible area information, the visible area position and the visible area width at the Z-coordinate position of a person position (i.e., at a distance in the Z-axis direction) (Step S14). Subsequently, the presentation image generating unit 120 sets the size of the angle of view of the camera at the Z-coordinate position of that person position to be the image size of the presentation image (Step S15).

Then, based on the visible area position and the visible area width at the Z-coordinate position of that person position, the presentation image generating unit 120 generates a presentation image by superimposing, on the observation image, information indicating whether the corresponding viewer is inside the visible area or outside the visible area (Step S16). Subsequently, the presentation image generating unit 120 sends the presentation image to the display unit 130, and the display unit 130 displays the presentation image (Step S17). For example, the display unit 130 can display the presentation image in some portion of the display screen. Moreover, the display unit 130 can display the presentation image in response to a signal received from an input device (such as a remote controller) (not illustrated). In this case, the input device can be equipped with button for issuing an instruction to display a presentation image.

The presentation image generating operation and the display operation from Step S14 to Step S17 are repeatedly performed for a number of times equal to the number of viewers obtained at Step S13. Herein, the generation and display of presentation images of a plurality of viewers is performed according to the display format illustrated in FIGS. 7 to 9.

In this way, in the first embodiment, a presentation image is generated in which whether a viewer is present inside the visible area or outside the visible area specified in the visible area information is superimposed on a viewer-by-viewer basis on an observation image that is obtained by observing the viewers. Then, the presentation image is displayed to the viewers. Hence, each of a plurality of viewers can get to know whether he or she is present inside the visible area or outside the visible area, and becomes able to view satisfactory stereoscopic images without difficulty.

Meanwhile, in the first embodiment, the explanation is given for a case in which a presentation image is displayed on the display unit 130. However, that is not the only possible case. Alternatively, for example, a presentation image can be displayed on a presentation device (such as a handheld device or a PC) (not illustrated) that is connectible to the image processing device 100 via a wired connection or a wireless connection. In this case, the presentation image generating unit 120 sends a presentation image to the presentation device, and then the presentation device displays that presentation image.

Meanwhile, it is desirable that the observing unit 110 is installed inside the display unit 130 or is attached to the display unit 130. However, alternatively, the observing unit 110 can also be installed independent of the display unit 130 and can be connected to the display unit 130 via a wired connection or a wireless connection.

### Second Embodiment

In a second embodiment, not only a presentation image explained in the first embodiment is displayed but also presentation information, which indicates a recommended destination that enables a viewer to move to a position within the visible area, is generated and displayed.

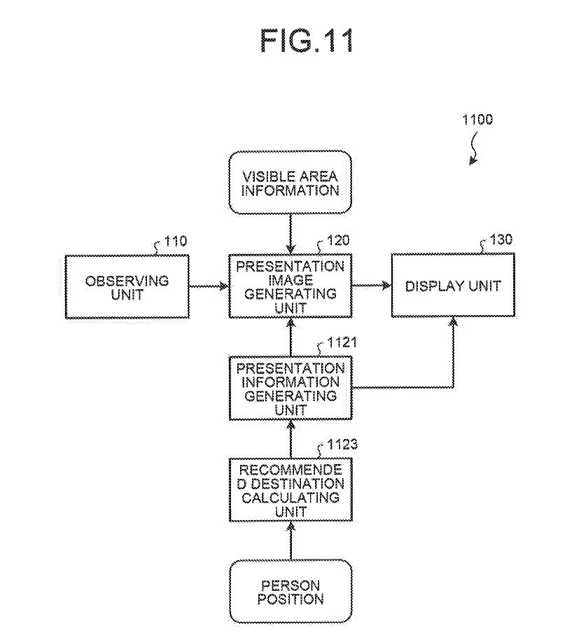

FIG. 11 is a block diagram illustrating a functional configuration of an image processing device 1100 according to the second embodiment. As illustrated in FIG. 11, the image processing device 1100 according to the second embodiment includes the observing unit 110, the presentation image generating unit 120, a presentation information generating unit 1121, a recommended destination calculating unit 1123, and the display unit 130. Herein, the observing unit 110, the presentation image generating unit 120, and the display unit 130 have the same functions and configuration as described in the first embodiment. Moreover, in an identical manner to the first embodiment, in the second embodiment too, the person positions of viewers and the visible area information are stored in advance in a memory medium such as a memory (not illustrated) in the image processing device 1100.

The recommended destination calculating unit 1123 obtains, based on the person positions of viewers and the visible area information, recommended destinations that indicate positions from which stereoscopic images can be viewed in a satisfactory manner. More particularly, it is desirable that the recommended destination calculating unit 1123 performs mapping of the person positions of existing viewers onto a map of visible area information (see FIG. 3); and if a viewer is present outside the visible area, obtains the direction to the nearest position in the visible area as the recommended destination. Herein, by obtaining the direction to the nearest position in the visible area as the recommended destination, the viewer is spared from having to make complicated decisions. Moreover, the recommended destination calculating unit 1123 is desirably configured to determine, based on the person positions and the visible information, whether or not a viewer is blocked by another viewer or a blocking material from the front. If that viewer is blocked by another viewer or a blocking material from the front, then the recommended destination calculating unit 1123 is desirably configured to not calculate, as the recommended destination, the direction to a position at which the other viewer or the blocking material is present.

As a result, for example, as the recommended destination, the recommended destination calculating unit 1123 can obtain the left-hand direction, the right-hand direction, the upward direction, or the downward direction in which the viewer should move from the current position.

The presentation information generating unit 1121 generates presentation information that contains the information indicating the recommended destination calculated by the recommended destination calculating unit 1123. Herein, the presentation information generating unit 1121 can generate the presentation information by appending or superimposing the presentation image generated by the presentation image generating unit 120 to the presentation information; or can generate the presentation information separately from the presentation image.

In an identical manner to the first embodiment, the presentation information generating unit 1121 sends the presentation information, which is generated in the manner described above, to the display unit 130; and the display unit 130 displays the presentation information to the viewers. In the case when the presentation information is generated separately from the presentation image, the display unit 130 can display the presentation information separately from the presentation image in, for example, some portion of the display. Alternatively, the display unit 130 can be configured to be a dedicated display device for displaying the presentation information.

Regarding the generation of presentation information by the presentation information generating unit 1121 using the recommended destination, the following description can be given.

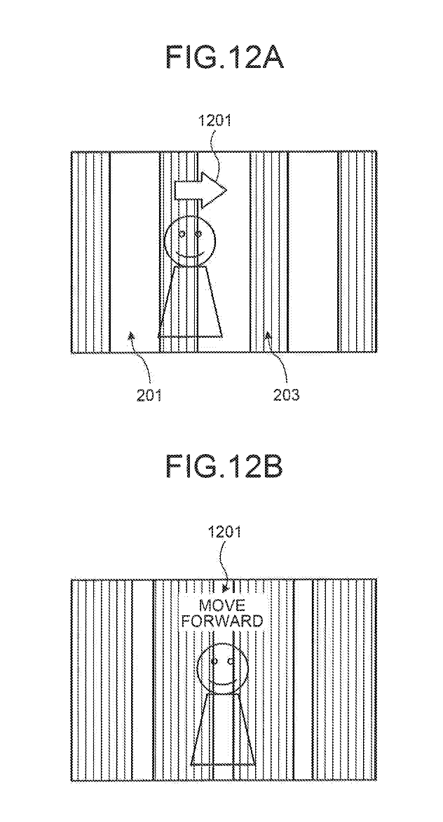

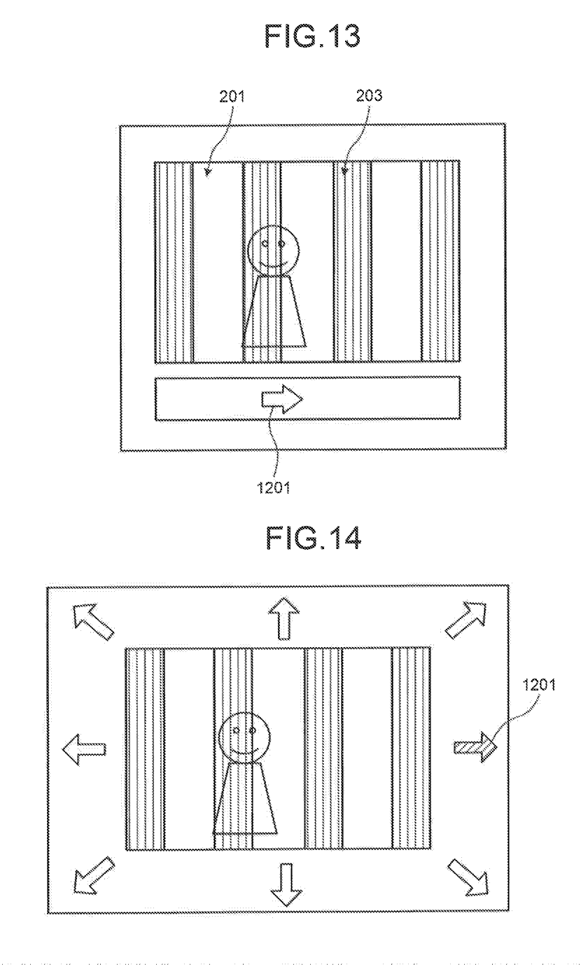

For example, as illustrated in FIG. 12(a) and FIG. 13, the presentation information generating unit 1121 generates presentation information in which a recommended destination 1201 is indicated by a directional sign such as an arrow, and appends the presentation information to a presentation image. Alternatively, as illustrated in FIG. 12(b), the presentation information generating unit 1121 generates presentation information in which the recommended destination 1201 is indicated by characters, and appends the presentation information to a presentation image.

As another example, as illustrated in FIG. 14, the presentation information generating unit 1121 appends dedicated direction indicator lamps to a presentation image; generates, as the presentation information, the image 1201 in which the direction indicator lamp in the destination direction is switched on; and appends the presentation information to the presentation image.

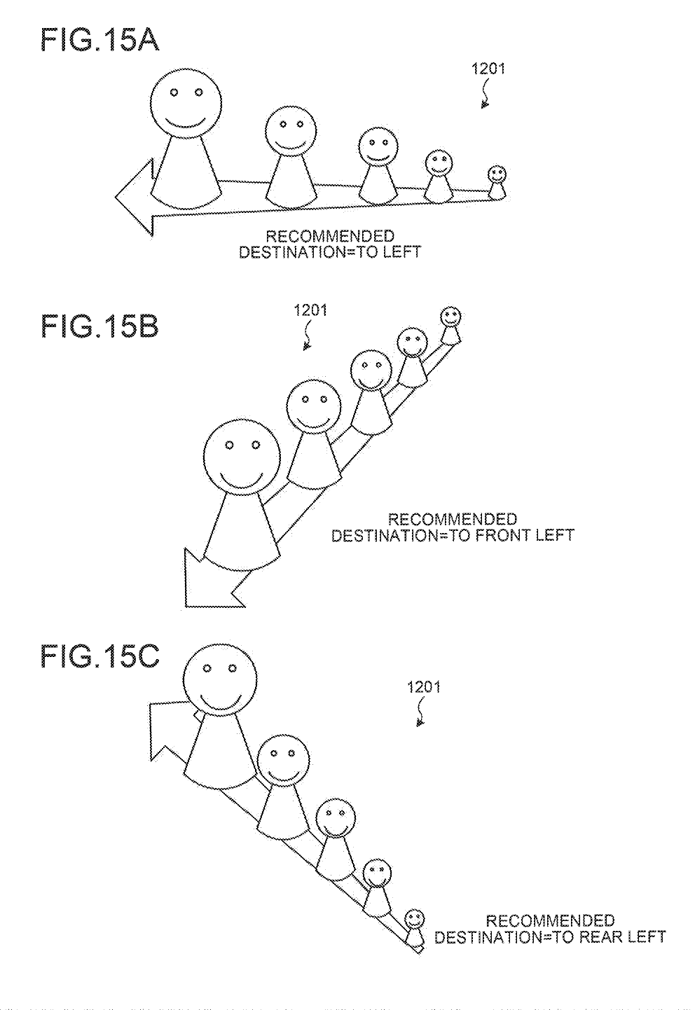

As still another example, as illustrated in FIG. 15(a) to FIG. 15(c); the presentation information generating unit 1121 generates, as the presentation information, human-shaped pictorial figures having ascending order of sizes toward the recommended destination 1201.

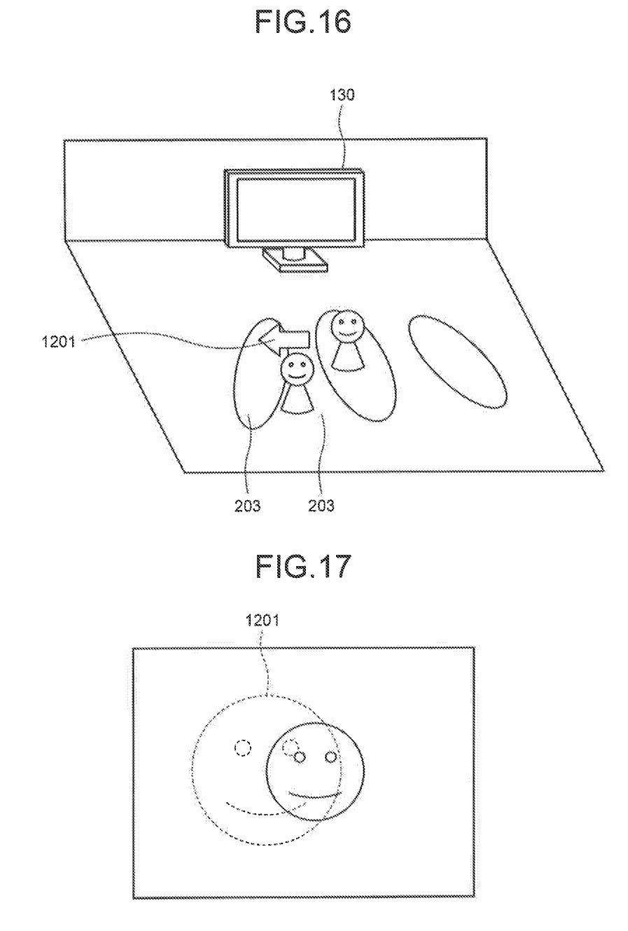

As still another example, as illustrated in FIG. 16, the presentation information generating unit 1121 makes use of an overhead view illustrating the display unit 130 and the viewing area and generates the presentation information in which the recommended destination 1201 is indicated as an arrow in the overhead view.

As still another example, as illustrated in FIG. 17, the presentation information generating unit 1121 generates presentation information in which the recommended destination points to an image 1201 that indicates the face of the viewer at the destination position in a display size suitable for that destination position. In this case, when the viewer moves to match with the size and position of the face image, it means that the recommended destination is indicated.

Meanwhile, in addition to displaying the recommended destination as the presentation information on the display unit 130, the configuration can be such that the viewer is notified about the recommended destination via an audio output.

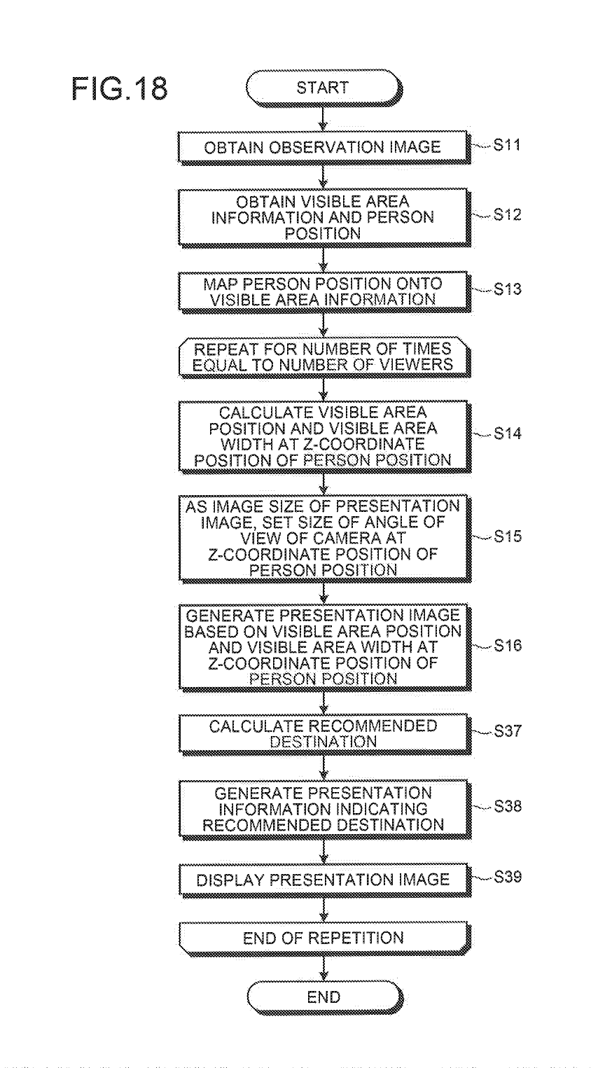

Explained below with reference to a flowchart illustrated in FIG. 18 is a presentation information generating operation performed in the image processing device 1100 configured in the abovementioned manner according to the second embodiment. During the presentation information generating operation, the operations from Step S11 to Step S16 are performed in an identical manner to the first embodiment.

Once the presentation image is generated, the recommended destination calculating unit 1123 implements the method described above and calculates the recommended destination by referring to the visible area information and the person positions of the viewers (Step S37). Then, the presentation information generating unit 1121 generates the presentation information that indicates the recommended destination (Step S38). Herein, the presentation information is generated by implementing one of the methods described above with reference to FIG. 12(a) to FIG. 17. Subsequently, the presentation image generating unit 120 sends the presentation information to the display unit 130, and the display unit 130 displays the presentation image and the presentation information (Step S39).

During the operation for generating and displaying the presentation image and the presentation information, Step S14 to Step S39 are repeatedly performed for a number of times equal to the number of viewers obtained at Step S13.

In this way, in the second embodiment, in addition to displaying a presentation image as described in the first embodiment; presentation information, which indicates a recommended destination that enables viewers to move to positions within the visible area, is generated and displayed. As a result, in addition to the effect achieved in the first embodiment, each of a plurality of viewers can easily understand his or her destination inside the visible area. As a result, it becomes possible to view satisfactory stereoscopic images without difficulty.

### Third Embodiment

In a third embodiment, depending on the visible area information and the person positions of viewers, it is determined whether or not to display the presentation information. Only when it is determined to display the presentation information, then the presentation information is generated and displayed.

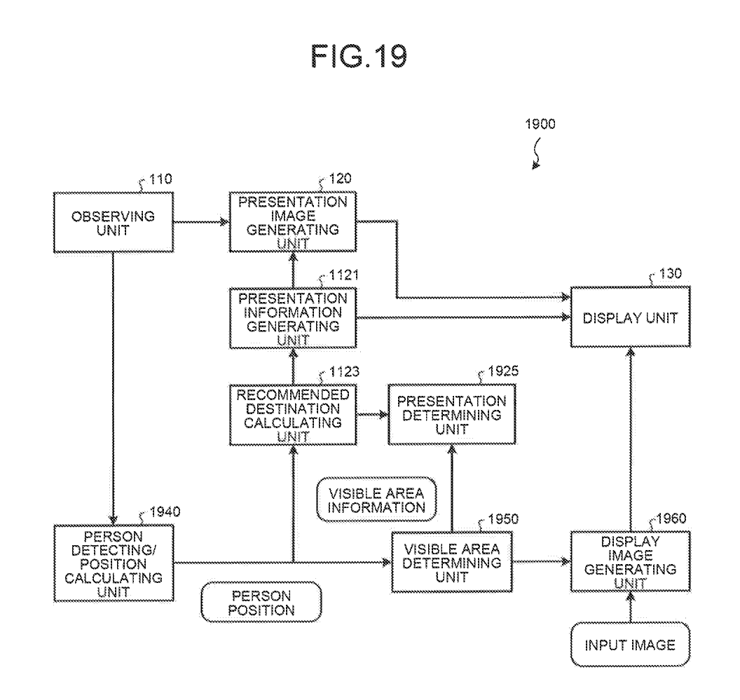

FIG. 19 is a block diagram illustrating a functional configuration of an image processing device 1900 according to the third embodiment. As illustrated in FIG. 19, the image processing device 1900 according to the third embodiment includes the observing unit 110, the presentation image generating unit 120, the presentation information generating unit 1121, the recommended destination calculating unit 1123, a presentation determining unit 1925, the display unit 130, a person detecting/position calculating unit 1940, a visible area determining unit 1950, and a display image generating unit 1960. Herein, the observing unit 110, the presentation image generating unit 120, the presentation information generating unit 1121, the recommended destination calculating unit 1123, and the display unit 130 have the same functions and configuration as described in the second embodiment.

The person detecting/position calculating unit 1940 detects, from the observation image generated by the observing unit 110, a viewer present within the viewing area and calculates person position coordinates that represent the position coordinates of that viewer in the real space.

More particularly, when the observing unit 110 is configured with a camera, the person detecting/position calculating unit 1940 performs image analysis of the observation image captured by the observing unit 110, and detects the viewer and calculates the person position. In contrast, when the observing unit 110 is configured with, for example, a radar; the person detecting/position calculating unit 1940 can be configured to perform signal processing of the signals provided by the radar, and to detect the viewer and calculate the person position. As far as the detection of a viewer performed by the person detecting/position calculating unit 1940 is concerned, it is possible to detect an arbitrary detection target such as the face, the head, the entire person, or a marker that enables detection of a person. Moreover, the detection of viewers and the calculation of person positions are performed by implementing known methods.

The visible area determining unit 1950 refers to the person positions of viewers as calculated by the person detecting/position calculating unit 1940 and determines the visible area from the person positions of viewers. Herein, it is desirable that the visible area determining unit 1950 sets the visible area determining method in such a way that as many viewers as possible are included in the visible area. Moreover, the visible area determining unit 1950 can set the visible area in such a way that particular viewers are included in the visible area without fail.

The display image generating unit 1960 generates a display image according to the visible area determined by the visible area determining unit 1950.

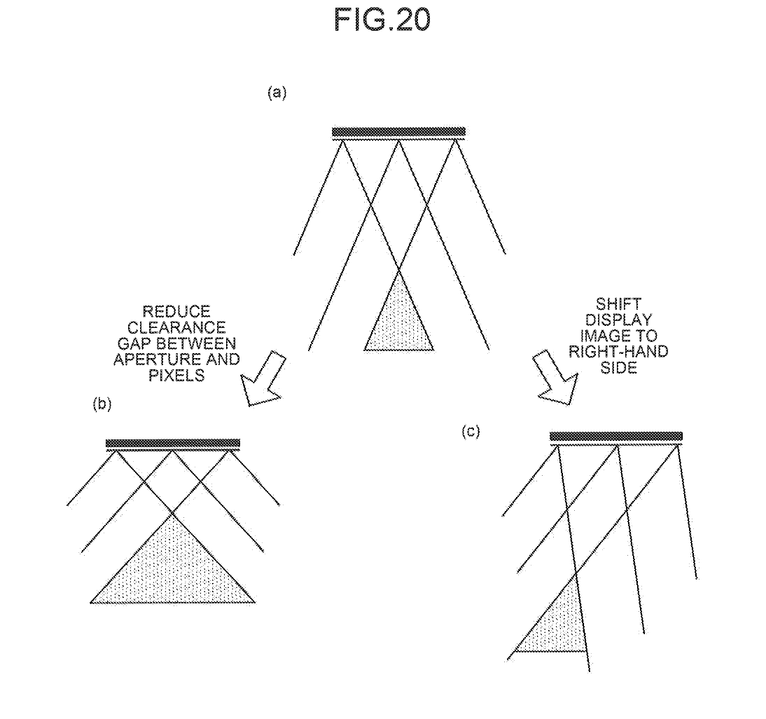

Given below is the explanation regarding controlling of the visible area. FIG. 20 is a diagram for explaining controlling of the visible area. FIG. 20(a) illustrates the basic relationship between the display unit 130, which serves as the display, and the corresponding visible area.

FIG. 20(b) illustrates a condition in which the clearance gap between the pixels of a display image and an aperture such as a lenticular lens is reduced so as to shift the visible area forward. In contrast, if the clearance gap between the pixels of a display image and an aperture such as a lenticular lens is increased, the visible area shifts backward.

FIG. 20(c) illustrates a condition in which a display image is shifted to the right-hand side so that the visible area shifts to the left-hand side. In contrast, if a display image is shifted to the left-hand side, the visible area shifts to the right-hand side. With such simple operations, it becomes possible to control the visible area.

Consequently, the display image generating unit 1960 can generate a display image according to the visible area that has been determined.

The presentation determining unit 1925 determines whether or not to generate presentation information based on the person positions of the viewers and based on the visible area information. The presentation information mainly fulfills the role of supporting the viewers who are not present within the visible area to move inside the visible area. As an example, following can be the criteria for which the presentation determining unit 1925 determines that the presentation information is not to be generated.

For example, when the person positions of all viewers are present within the visible area, or when the person positions of particular viewers are present within the visible area, or when a two-dimensional image is being displayed on the display unit 130, or when a viewer instructs not to display the presentation information; the presentation determining unit 1925 determines that the presentation information is not to be generated.

Herein, a particular viewer points to a viewer who is registered in advance, or who possesses a remote controller, or who has different properties than the other viewers.

The presentation determining unit 1925 performs such determination by identifying the viewers or detecting a remote controller using a known image recognition operation or using detection signals from a sensor. The instruction by a viewer not to display the presentation information is input by operating a remote controller or a switch. The presentation determining unit 1925 is configured to detect the event of operation input and accordingly determine that an instruction not to display the presentation information has been issued by a viewer.

As an example, following can be the criteria for which the presentation determining unit 1925 determines that the presentation information is to be generated.

For example, when a particular viewer is not present within the visible area, or when viewing of stereoscopic images is started, or when a viewer has moved, or when there is an increase or decrease in the number of viewers, or when a viewer instructs to display the presentation information; the presentation determining unit 1925 determines that the presentation information is to be generated.

At the start of the viewing of stereoscopic images, particularly the stereoscopic viewing condition of the viewers is not clear. Hence, it is desirable to present the presentation information. Moreover, when a viewer moves, the stereoscopic viewing condition of that viewer undergoes a change. Hence, it is desirable to present the presentation information. Furthermore, when there is an increase or decrease in the number of viewers, particularly the stereoscopic viewing condition of the newly-added viewers is not clear. Hence, it is desirable to present the presentation information.

The presentation information generating unit 1121 generates the presentation information when the presentation determining unit 1925 determines that the presentation information is to be generated.

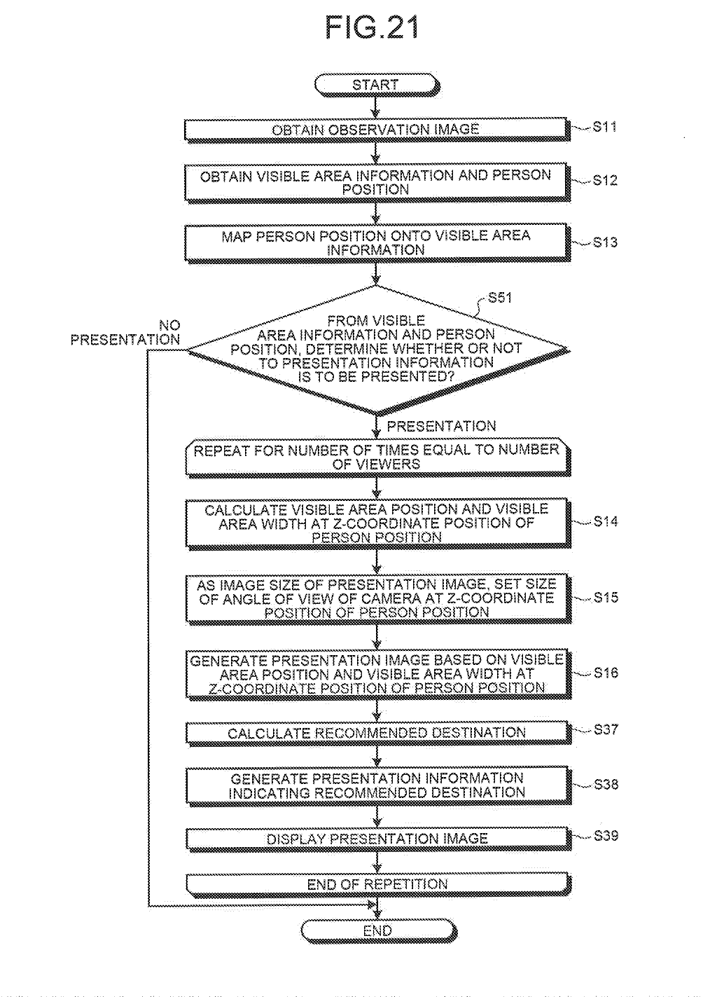

Explained below with reference to a flowchart illustrated in FIG. 21 is a presentation information generating operation performed in the image processing device 1900 configured in the abovementioned manner according to the third embodiment. Herein, during the presentation information generating operation, the operations from Step S11 to Step S16 are performed in an identical manner to the first embodiment.

Firstly, the observing unit 110 observes the viewers and obtains an observation image (Step S11). Then, the visible area determining unit 1950 determines the visible area information, and the person detecting/position calculating unit 1940 detects the viewers and determines the person positions (Step S12).

Subsequently, the presentation image generating unit 120 performs mapping of the person positions onto the visible area information (Step S13), and gets to know the number of viewers and the position of each viewer in the visible area information.

Then, from the visible area information and the person positions, the presentation determining unit 1925 determines whether or not to present the presentation information by implementing the abovementioned determination method (Step S51). If it is determined that the presentation information is not to be generated (no presentation at Step S51), then that marks the end of the operations without generating and displaying the presentation information and the presentation image. However, in this case, the configuration can be such that only the presentation image is generated and displayed.

On the other hand, at Step S51, if it is determined that the presentation information is to be generated (presentation at Step S51), then the system control proceeds to Step S14. Subsequently, in an identical manner to the second embodiment, the presentation image and the presentation information are generated and displayed (Steps S14 to S39).

In this way, in the third embodiment, whether or not to display the presentation information is determined based on the visible area information and the person positions of the viewers. If it is determined that the presentation information is to be displayed, the presentation information is generated and displayed. Hence, in addition to the effect achieved in the second embodiment, the convenience for the viewers is enhanced and it becomes possible to view satisfactory stereoscopic images without difficulty.

Thus, according to the first to third embodiments, it becomes possible for a viewer to easily recognize whether his or her current viewing position is within the visible area. As a result, the viewer can view satisfactory stereoscopic images without difficulty.

Meanwhile, an image processing program executed in the image processing devices 100, 1100, and 1900 according to the first to third embodiments is stored in advance in a ROM as a computer program product.

Alternatively, the image processing program executed in the image processing devices 100, 1100, and 1900 according to the first to third embodiments can be recorded in the form of an installable or executable file in a computer-readable recording medium such as a CD-ROM, a flexible disk (FD), a CD-R, and a DVD (Digital Versatile Disk).

Still alternatively, the image processing program executed in the image processing devices 100, 1100, and 1900 according to the first to third embodiments can be saved as a downloadable file on a computer connected to a network such as the Internet or can be made available for distribution through a network such as the Internet.

Meanwhile, the image processing program executed in the image processing devices 100, 1100, and 1900 according to the first to third embodiments contains a module for each of the abovementioned constituent elements (the observing unit, the presentation image generating unit, the presentation information generating unit, the recommended destination calculating unit, the presentation determining unit, the display unit, the person detecting/position calculating unit, the visible area determining unit, and the display image generating unit) to be implemented in a computer. As the actual hardware, for example, a CPU (processor) reads the image processing program from the abovementioned ROM and runs it such that the program is loaded in a main memory device. As a result, the module for each of the abovementioned constituent elements is loaded in a main memory device. As a result, the observing unit, the presentation image generating unit, the presentation information generating unit, the recommended destination calculating unit, the presentation determining unit, the display unit, the person detecting/position calculating unit, the visible area determining unit, and the display image generating unit are generated in the main memory device.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device comprising:
an observing unit configured to obtain an observation image by observing a viewer which views a display unit, the display unit being capable of displaying a stereoscopic image; and
a generating unit configured to generate a presentation image in which visible area is superimposed on the observation image by using visible area information indicating the visible area, the visible area being an area within which the viewer is able to view the stereoscopic image, a display form of the visible area changing based on a position of the viewer in a perpendicular direction to the display unit.

2. The image processing device according to claim 1, wherein
the observing unit obtains position information of the viewer, and
the generating unit generates the presentation image based on the position information of the viewer and the visible area information.

3. The image processing device according to claim 2, wherein
the generating unit generates the presentation image so that a width of the visible area changes based on the position of the viewer in the perpendicular direction to the display unit.

4. The image processing device according to claim 3, wherein
the generating unit generates the presentation image so that the visible area or an area outside the visible area is formed in a lattice form and a width of the lattice form changes based on a distance of the viewer from the display unit in the perpendicular direction to the display unit.

5. The image processing device according to claim 2, wherein, when a plurality of viewers is present, the generating unit generates the presentation image by superimposing, on the observation image, the visible area corresponding to one or more of the viewers who are selected.

6. The image processing device according to claim 1, wherein
the observation image is an image in which the viewer is captured from the position of the display unit, and
the generating unit generates the presentation image by superimposing, on the observation image, the visible area corresponding to a photographed surface of the observation image.

7. The image processing device according to claim 1, further comprising:
a calculating unit configured to, based on the position information of the viewer and the visible area information, obtain a recommended destination being recommended to the viewer in order to enable stereoscopic image viewing; and
a presentation information generating unit configured to generate presentation information indicating the recommended destination.

8. The image processing device according to claim 7, wherein the calculating unit obtains, as the recommended destination, the direction from among the right-hand direction and the left-hand direction in which the viewer should move from the current position.

9. The image processing device according to claim 7, wherein the calculating unit obtains, as the recommended destination, the direction from among the forward direction and the backward direction in which the viewer should move from the current position.

10. The image processing device according to claim 7, further comprising a presentation determining unit that, based on the position information of the viewer and the visible area information, determines whether or not the presentation information is to be generated, wherein
when it is determined that the presentation information is to be generated, the presentation information generating unit generates the presentation information.

11. An image processing method comprising:
obtaining an observation image by observing a viewer which views a display unit, the display unit being capable of displaying a stereoscopic image; and
generating a presentation image in which visible area is superimposed on the observation image by using visible area information indicating the visible area, the visible area being an area within which the viewer is able to view the stereoscopic image, a display form of the visible area changing based on a position of the viewer in a perpendicular direction to the display unit.

12. A computer program product having a non-transitory computer readable medium including programmed instructions, wherein the instructions, when executed by a computer, cause the computer to perform:
obtaining an observation image by observing a viewer which views a display unit, the display unit being capable of displaying a stereoscopic image; and
generating a presentation image in which visible area is superimposed on the observation image by using visible area information indicating the visible area, the visible area being an area within which the viewer is able to view the stereoscopic image, a display form of the visible area changing based on a position of the viewer in a perpendicular direction to the display unit.

13. A stereoscopic image display device comprising:
A display unit configured to be capable of displaying a stereoscopic image;
an observing unit configured to obtain an observation image by observing a viewer which views the display unit; and
a generating unit configured to generate a presentation image in which visible area is superimposed on the observation image by using visible area information indicating the visible area, the visible area being an area within which the viewer is able to view the stereoscopic image, a display form of the visible area changing based on a position of the viewer in a perpendicular direction to the display unit.
